(19) United States
(12) Patent Application Publication
(10) Pub. No.: US 2025/0053794 A1
(43) Pub. Date: Feb. 13, 2025

(54) SYSTEM AND METHOD FOR DESIGNING CURING PROCESSES USING GENERATIVE AI

(71) Applicant: Quantiphi, Inc., Marlborough, MA (US)

(72) Inventors: Dagnachew Birru, Marlborough, MA (US); Anirudh Deodhar, Mumbai (IN); Milad Ramezankhani, Toronto (CA); Muneeswaran I, Mumbai (IN); Saisubramaniam Gopalakrishnan, Mumbai (IN); Goutham Vignesh Saravanan, Mumbai (IN)

(21) Appl. No.: 18/902,142

(22) Filed: Sep. 30, 2024

(51) Int. Cl. G06N 3/0475

(52) U.S. Cl. CPC G06N 3/0475

(57) ABSTRACT

A method and system for designing curing processes is disclosed. The method includes obtaining design requirements using a requirement gathering agent, determining potential ranges of recipes and operating conditions with an operations specialist agent, identifying suitable material options and assessing corresponding properties with a material specialist agent, defining dimensions and shape aspects of the design using a design specialist agent, extracting and reasoning relevant information with a knowledge processing and retrieval agent, formulating a final requirement specification with an experiment enabler agent, generating a first set of experiments based on the final requirement specifications using an experiment designer, performing, by a predictive model design agent implementing a prediction model, real-time predictions for dynamic conditions, updating, by a predictive model optimizer agent implementing a continual learning framework, the prediction model in real-time; and optimizing and updating, by a process optimizer agent, the prediction model iteratively based on feedback from experiments and simulations.

### FIELD OF THE INVENTION

The present disclosure relates to manufacturing processes, and more specifically to a method and system for designing curing processes for composite materials using Generative Artificial Intelligence (Gen AI).

### BACKGROUND OF THE INVENTION

The curing process in composite material manufacturing is critical as it determines mechanical properties and performance of a final product. Manufacturing of composite materials, particularly the curing process, is a complex and expertise-intensive task. Traditional methods for designing curing processes involve a combination of first-principles modeling, empirical experimentation, and iterative adjustments based on experimental feedback. These methods, however, face several limitations:

First-Principles Modeling: While valuable, first-principles models are often limited in their ability to capture the full complexity of curing processes. It requires extensive domain expertise and is time and compute intensive.

Pure Data-Driven Approaches: Data-driven models rely heavily on historical data and are typically condition-specific. These approaches lack the flexibility to generalize across different scenarios and often fail when extrapolating beyond the range of their training data.

Hybrid Models (e.g., PINNs): Hybrid approaches, such as Physics-Informed Neural Networks (PINNs), combine the strengths of first principles and data-driven methods. However, these methods still face challenges, particularly in predicting parameters outside their training range and adapting to real-time, dynamic conditions.

Experiment-Driven Design: Designing experiments and utilizing the resulting data traditionally requires significant human expertise. This process is time-consuming and prolongs the design cycle. Additionally, the nature of these models makes it difficult to implement ‘online’ process design, where real-time updates and adjustments are crucial.

The process of design and development requires human experience and expertise across multiple stages including identifying the right set of candidate materials, right set of design curing cycles considering the materials chosen, identifying the right design dimensions via-a-vis the end requirement-constraints as well as materials and curing cycles chosen. Further, the predictive model that is used may have to be tuned or built for a specific set of design dimensions of interest. Additionally, building and tuning predictive models for specific design dimensions is highly expert-intensive. Designing the optimal number of real-life experiments, which are slow and costly, is also a crucial task. Current challenges in the manufacturing industry include cost effective design and manufacturing while facing the shortage of expertise. Therefore, there is a need for a system and method that can automate some tasks and assist human decision-making through the use of advanced technologies like generative AI models and multi-agentic workflows. These technologies offer unprecedented capabilities to automate complex processes and optimize decision-making, thereby alleviating some of the burdens traditionally carried by experts.

### SUMMARY

The following embodiments presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Some example embodiments disclosed herein provide a computer-implemented system for designing curing processes using Gen AI, the computer-implemented system includes a requirement gathering agent for obtaining design requirements. The computer-implemented system may further include an operations specialist agent for determining potential ranges of recipes and operating conditions based on obtained design requirements, material options, and design options. The computer-implemented system may further include a material specialist agent for identifying suitable material options and assessing corresponding properties to meet design objectives. The computer-implemented system may further include a design specialist agent for defining dimensions and shape aspects of the design based on gathered requirements, material options, and operating conditions. The computer-implemented system may further include a knowledge processing and retrieval agent for extracting and reasoning relevant information specific to design, operation, and materials. The computer-implemented system may further include an experiment enabler agent for formulating a final requirement specification. The computer-implemented system may further include an experiment designer for generating a first set of experiments based on the final requirement specifications. The computer-implemented system may further include a predictive model design agent implementing a prediction model for real-time predictions for dynamic conditions. The computer-implemented system may further include a predictive model optimizer agent implementing a continual learning framework associated with the prediction model design agent, wherein the continual learning framework is configured for updating the prediction model in real-time. The computer-implemented system may further include a process optimizer agent associated with the predictive model optimizer agent for optimizing and updating the prediction model iteratively based on feedback from experiments and simulations.

According to some example embodiments, wherein the prediction model is a physics informed neural operator (PINO) model.

According to some example embodiments, wherein the prediction model is a pre-trained model and trained using a dataset comprising physics-based simulations and real-world experimental data.

According to some example embodiments, wherein the prediction model is further trained in a semi-supervised fashion based on input variations during an initial stage of virtual curing experiments.

According to some example embodiments, wherein the first set of experiments is generated through the experiment designer using a predefined design of experiments (DOE) approach.

According to some example embodiments, wherein one or more agents and the optimization component comprises a Generative Artificial Intelligence (Gen AI) model.

According to some example embodiments, wherein the Gen AI generates structured prompts tailored to specific requirements of a curing process.

According to some example embodiments, the system further comprising a graphical user interface (GUI) facilitating user input of design parameters, visualization of optimization results, and a receipt of the feedback.

According to some example embodiments, wherein the continual learning framework employs at least one of techniques comprising online gradient descent, Bayesian optimization, reinforcement learning, a regularization technique, architectural changes and data replay mechanisms to adaptively update the prediction model.

According to some example embodiments, the system further comprising a resource management module configured to allocate resources for training, experimental design, and optimization tasks.

Some example embodiments disclosed herein provide computer-implemented method for designing curing processes using Gen AI, the method may include obtaining design requirements using a requirement gathering agent, determining potential ranges of recipes and operating conditions with an operations specialist agent, identifying suitable material options and assessing corresponding properties with a material specialist agent, defining dimensions and shape aspects of the design using a design specialist agent, extracting and reasoning relevant information with a knowledge processing and retrieval agent, formulating a final requirement specification with an experiment enabler agent, and generating a first set of experiments based on the final requirement specifications using an experiment designer. The method may further include performing, by a predictive model design agent implementing a prediction model, real-time predictions for dynamic conditions. The method may further include updating, by a predictive model optimizer agent implementing a continual learning framework associated with the prediction model design agent, the prediction model in real-time. The method may further include optimizing and updating, by a process optimizer agent associated with the predictive model optimizer agent, the prediction model iteratively based on feedback from experiments and simulations.

Some example embodiments disclosed herein provide a non-transitory computer readable medium having stored thereon computer executable instruction which when executed by one or more processors, cause the one or more processors to carry out operations for designing curing processes using Gen AI, the operations comprising obtaining design requirements using a requirement gathering agent, determining potential ranges of recipes and operating conditions with an operations specialist agent, identifying suitable material options and assessing corresponding properties with a material specialist agent, defining dimensions and shape aspects of the design using a design specialist agent, extracting and reasoning relevant information with a knowledge processing and retrieval agent, formulating a final requirement specification with an experiment enabler agent, and generating a first set of experiments based on the final requirement specifications using an experiment designer. The operations further comprising performing, by a predictive model design agent implementing a prediction model, real-time predictions for dynamic conditions. The operations further comprising updating, by a predictive model optimizer agent implementing a continual learning framework associated with the prediction model design agent, the prediction model in real-time. The operations further comprising optimizing and updating, by a process optimizer agent associated with the predictive model optimizer agent, the prediction model iteratively based on feedback from experiments and simulations.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The above and still further example embodiments of the present invention will become apparent upon consideration of the following detailed description of embodiments thereof, especially when taken in conjunction with the accompanying drawings, and wherein:

FIG. 1 is a block diagram of an environment of a system for designing curing processes using Gen AI, in accordance with an example embodiment.

FIG. 2 is a block diagram illustrating various modules within a memory of a computing device configured for designing curing processes using Gen AI, in accordance with an example embodiment.

FIGS. 3A and 3B illustrates a flow diagram of a method for designing curing processes using Gen AI, in accordance with an example embodiment.

FIG. 4 illustrates a flow diagram of a method for pre-training a prediction model, in accordance with an example embodiment.

FIG. 5 illustrates a flow diagram of a method for generating curing experiments, in accordance with an example embodiment.

FIG. 6 illustrates an exemplary architecture of the prediction model for designing curing processes using Gen AI, in accordance with an example embodiment.

FIG. 7A illustrates an exemplary autoclave setup for composite material, in accordance with an example embodiment.

FIG. 7B illustrates a corresponding temperature and degree of cure profiles over time for the autoclave setup, in accordance with an example embodiment.

FIGS. 8A and 8B illustrate an exemplary workflow for Gen AI-assisted composite curing designer, in accordance with an example embodiment.

FIGS. 9 illustrates a detailed block diagram for Gen AI-assisted composite curing designer, in accordance with an example embodiment.

FIG. 10 illustrates an exemplary block diagram for a semi supervised update (pre-trained) curing predictor model without real experiment data, in accordance with an example embodiment.

FIG. 11 illustrates an exemplary block diagram for a creating optimal curing experiments using a curing optimizer, in accordance with an example embodiment.

FIGS. 12A and 12B illustrate tables depicting different types of agents and their roles in designing curing processes, in accordance with an example embodiment.

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION

In the following description, for purposes of explanation, numerous specific details are set forth in order to provide a thorough understanding of the present invention. It will be apparent, however, to one skilled in the art that the present invention can be practiced without these specific details. In other instances, systems, apparatuses, and methods are shown in block diagram form only in order to avoid obscuring the present invention.

Reference in this specification to “one embodiment” or “an embodiment” or “example embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

The terms “comprise”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect.

### Definitions

The term “Physics-Informed Neural Operators (PINOs)” may represent a type of machine learning framework that combines principles from physics with neural network architectures, for mapping relationships between functional spaces. These PINOs are utilized for modeling complex systems, particularly those characterized by nonlinear dynamics, long temporal domains, and discontinuities.

The term “machine learning model” may be used to refer to a computational or statistical or mathematical model that is trained on classical ML modelling techniques with or without classical image processing. The “machine learning model” is trained over a set of data and using an algorithm that it may be used to learn from the dataset.

The term “artificial intelligence” may be used to refer to a model built using simple or complex Neural Networks using deep learning techniques and computer vision algorithms. Artificial intelligence model learns from the data and applies that learning to achieve specific pre-defined objectives.

The term “Generative AI (GenAI)” refers to artificial intelligence systems capable of understanding requests and generating responses across various modalities, including but not limited to text, images, code, and other formats. These GenAI models are utilized for purposes such as, but not limited to, generation, conversation, optimization of processes and models, among other applications.

The term “agent” refer to an AI system powered by the GenAI models that autonomously perform intermediate tasks using a set of tools and actions. It utilizes planning and reasoning capabilities based on contextual information to make informed decisions. These agents communicate with one another and engage in complex interactions with the user to collaboratively achieve their respective objectives. The agent may include memory and generative AI models to ensure all necessary requirements are gathered and clearly defined.

The term “module” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

### End of Definitions

As described earlier, traditional methods of designing curing processes rely heavily on human expertise and conventional numerical methods, which are time-consuming and often suboptimal. The present disclosure addresses these challenges by introducing a method and system for designing curing processes using generative AI powered agents. The proposed method and system uses pre-trained and dynamically adaptable Hybrid (physics-informed and data-driven) neural operators coupled with optimizer for effective knowledge and data-driven design generation, testing and evaluation. Further, the proposed method and system uses adaptive workflow for design optimal experiment generation, model training, experiment execution, model update and final design optimization.

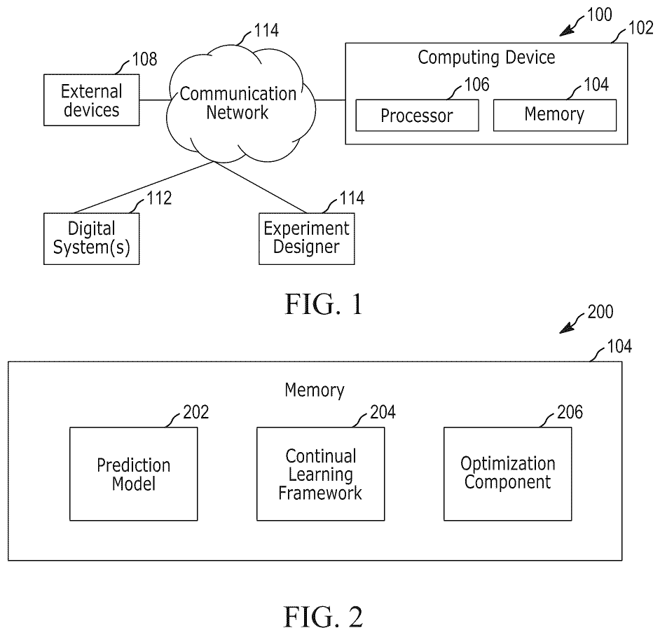

Embodiments of the present disclosure may provide a method, a system, and a computer program product for designing curing processes. The method, the system, and the computer program product designing curing processes in such an improved manner are described with reference to FIG. 1 to FIG. 7 as detailed below.

FIG. 1 illustrates a block diagram of an environment of a system 100 for designing curing processes, in accordance with an example embodiment. The system 100 is designed to facilitate efficient and accurate design of curing processes by utilizing advanced computational techniques and automated experiment design. The system 100 includes a computing device 102, external devices 108, experiment designer 110 and digital system(s) 112. The computing device 102 may be communicatively coupled with one of the external devices 108, experiment designer 110 and digital system(s) 112 via a communication network 114. Examples of the computing device 102 may include, but are not limited to, a server, a desktop, a laptop, a notebook, a tablet, a smartphone, a mobile phone, an application server, or the like.

The communication network 112 may be wired, wireless, or any combination of wired and wireless communication networks, such as cellular, Wi-Fi, internet, local area networks, or the like. In one embodiment, the network 112 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The computing device 102 may include a memory 104, and a processor 106. The term “memory” used herein may refer to any computer-readable storage medium, for example, volatile memory, random access memory (RAM), non-volatile memory, read only memory (ROM), or flash memory. The memory 104 may include a Random-Access Memory (RAM), a Read-Only Memory (ROM), a Complementary Metal Oxide Semiconductor Memory (CMOS), a magnetic surface memory, a Hard Disk Drive (HDD), a floppy disk, a magnetic tape, a disc (CD-ROM, DVD-ROM, etc.), a USB Flash Drive (UFD), or the like, or any combination thereof.

The term “processor” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The processor 106 may retrieve computer program code instructions that may be stored in the memory 104 for execution of the computer program code instructions. The processor 106 may be embodied in a number of different ways. For example, the processor 106 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 106 may include one or more processing cores configured to perform independently. A multi-core processor may enable multiprocessing within a single physical package. Additionally, or alternatively, the processor 106 may include one or more processors configured in tandem via the bus to enable independent execution of instructions, pipelining and/or multithreading.

Additionally, or alternatively, the processor 106 may include one or more processors capable of processing large volumes of workloads and operations to provide support for big data analysis. In an example embodiment, the processor 106 may be in communication with a memory 104 via a bus for passing information among components of the system 100.

The memory 104 may be non-transitory and may include, for example, one or more volatile and/or non-volatile memories. In other words, for example, the memory 104 may be an electronic storage device (for example, a computer readable storage medium) comprising gates configured to store data (for example, bits) that may be retrievable by a machine (for example, a computing device like the processor 106). The memory 104 may be configured to store information, data, contents, applications, instructions, or the like, for enabling the apparatus to carry out various functions in accordance with an example embodiment of the present disclosure. For example, the memory 104 may be configured to buffer input data for processing by the processor 106.

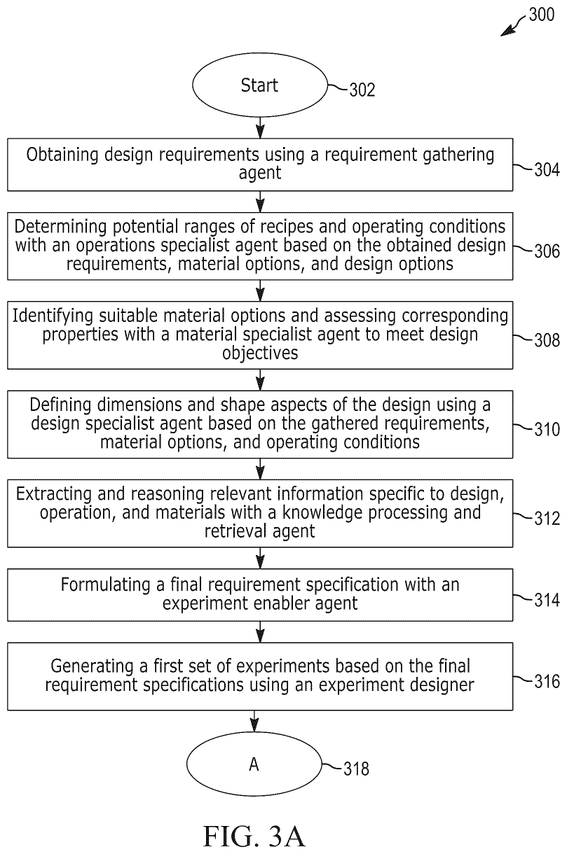

The computing device 102 may be capable of designing curing processes. The memory 104 may store instructions that, when executed by the processor 106, cause the computing device 102 to perform one or more operations of the present disclosure which will be described in greater detail in conjunction with FIG. 2. The computing device 102 is responsible for running a prediction model, which is configured for real-time predictions under dynamic conditions. The computing device 102 hosts a continual learning framework that updates the prediction model in real-time based on incoming data. Additionally, it manages the optimization component, which iteratively optimizes the curing process using feedback from both simulations and real-world experiments. The computing device 102 is equipped with sufficient computational power and memory to handle the complex calculations and data processing tasks required by the system 100.

The external devices 108 may refers to various hardware and software tools that may be integrated with the system 100 to enhance its functionality. These devices may include sensors, actuators, and other measurement instruments that provide real-time data from the curing process. For example, temperature sensors, humidity sensors, and pressure sensors may feed critical process parameters back to the computing device 102. This real-time data is essential for the continual learning framework to make accurate updates to the prediction model and ensure the optimization component may refine the curing process effectively.

The experiment designer 110 is a crucial component of the system 100, responsible for generating the initial set of experiments. It uses predefined design of experiments (DOE) approaches, such as the Taguchi method, to create structured experimental plans. Additionally, the experiment designer 110 utilizes a large language model (Gen AI) to optimize these plans further. The Gen Al generates structured prompts tailored to the specific requirements of the curing process, ensuring that the experiments are designed efficiently and effectively. By automating the experiment design process, the system reduces the dependency on human expertise and accelerates the overall design cycle.

The digital system(s) 112 encompass various computational and analytical tools that support the operation of the system 100. These digital systems may include digital twins, simulation platforms, and data analytics tools that provide a virtual representation of the curing process. The digital systems 112 enable in vitro experimentation, allowing for the testing and validation of different curing scenarios without physical trials. This capability is essential for optimizing the curing process in a cost-effective and time-efficient manner. The digital systems 112 work in tandem with the computing device 102 to ensure seamless integration and data flow.

The system 100 is equipped with a graphical user interface (GUI) that facilitates user input of design parameters, visualization of optimization results, and receipt of feedback. This interface ensures that users may interact with the system intuitively and efficiently, enhancing the overall user experience.

Additionally, the system 100 includes a resource management module that allocates resources for training, experimental design, and optimization tasks. This module ensures that computational and experimental resources are used optimally, contributing to the system's overall efficiency and effectiveness. The complete process followed by the system 100 is explained in detail in conjunction with FIG. 2 to FIG. 7.

FIG. 2 illustrates a block diagram 200 illustrating various modules within the memory 104 of the computing device 102 configured for designing curing processes, in accordance with an example embodiment. The memory 104 may include a prediction model 202, a continual learning framework 204, and an optimization component 206.

The prediction model 202 is responsible for making real-time predictions about the curing process under dynamic conditions. The dynamic conditions refer to varying parameters in the manufacturing environment, such as changes in temperature, pressure, humidity, material properties, and other external factors that may influence the curing process. The prediction model 202 is designed to account for these variations and provide accurate predictions regardless of these fluctuations. Specifically, the prediction model 202 is a physics-informed neural operator (PINO) model. This model leverages governing physical laws to learn the underlying dynamics of physical systems in a data-efficient manner. It may also utilize data from physics-based simulations with real-world experimental data to provide accurate and reliable predictions. The real-world experimental data encompasses empirical measurements and observations collected from actual manufacturing processes, including temperature profiles, pressure readings, material behavior, and curing duration. This data is crucial for training the prediction model 202 to reflect the true behavior of the curing process under practical conditions.

The prediction model 202 is pre-trained using governing physical equations in a physics-informed manner. It may also utilize a comprehensive dataset comprising both physics-based simulations and empirical data, ensuring that it may generalize well across different scenarios. Different scenarios in curing processes encompass a wide range of environmental conditions (such as, temperature fluctuations, humidity variations, and pressure changes), material properties (such as, different composite and tooling materials, material thickness and density), process parameters (such as, curing time, air temperature, heating rates, cooling rates, and tooling and Mold designs), real-world variations (such as, manufacturing defects, batch-to-batch variations, and process interruptions), specific application requirements (such as, aerospace applications, automotive applications, and marine applications), and both virtual and real-world implementations.

During the initial stage of virtual curing experiments, the prediction model 202 is trained in a semi-supervised fashion, in a physics-informed fashion. This involves using input variations to enhance the prediction model ability to predict outcomes even with limited initial data. The semi-supervised training approach allows the prediction model 202 to leverage both labeled and unlabeled data, improving its performance and robustness.

The continual learning framework 204 is designed to update the prediction model 202 in real-time as new data becomes available. This framework ensures that the prediction model 202 remains accurate and relevant by continuously learning from new inputs and feedback. The continual learning framework 204 employs advanced techniques such as, but not limited to, online gradient descent, Bayesian optimization, reinforcement learning, regularization methods, architectural adjustments, and memory/data replay methods to adaptively update the prediction model 202.

Online gradient descent is a variant of gradient descent optimization that updates the model's parameters based on individual data samples or mini batches, rather than the entire dataset at once. This approach is particularly useful in scenarios where data arrives sequentially or in a streaming fashion, making it impractical to process the entire dataset at once. These techniques allow the prediction model 202 to efficiently incorporate new information and adjust its parameters, minimizing the need for manual intervention. This technique allows for continuous learning and adaptation to new data without requiring batch processing, efficiently handles large datasets and streaming data by updating the model incrementally and enables the model to adapt quickly to changes in the underlying data distribution. The continual learning framework may update the prediction model parameters using gradients computed from individual data samples or mini batches, adjusting the model in the direction that minimizes the loss function.

Bayesian optimization is a probabilistic optimization technique used to find the optimal configuration of hyperparameters for a given model. It combines prior knowledge about the objective function with observed data to iteratively improve the model's performance. Bayesian optimization is particularly effective in scenarios with expensive-to-evaluate objective functions, such as hyperparameter tuning in machine learning models. This technique efficiently explores the hyperparameter space by balancing exploration and exploitation, adapts the search based on previous evaluations, focusing on promising regions of the parameter space, and provides uncertainty estimates, allowing for principled decision-making and robustness to noise. The continual learning framework may use Bayesian optimization to search for optimal hyperparameters for the prediction model, such as learning rates, regularization parameters, or network architectures.

Reinforcement learning (RL) is a machine learning paradigm where an agent learns to make sequential decisions by interacting with an environment to maximize cumulative rewards. In the context of continual learning, RL can be used to adaptively adjust the prediction model's behavior based on feedback from the environment or user interactions. RL algorithms, such as Q-learning or policy gradients, learn a policy that maps states to actions, allowing the model to adapt its behavior over time. This technique enables the prediction model to learn from feedback in dynamic environments or user interactions, facilitates adaptive decision-making and behavior optimization based on changing objectives or constraints, and allows for the incorporation of domain knowledge or prior preferences through reward shaping. The continual learning framework may employ reinforcement learning algorithms to optimize the prediction model's actions or parameters based on feedback from the environment or user interactions.

The regularization methods are employed to prevent overfitting and maintain model generalization by incorporating penalties on the model's complexity or parameters. Techniques such as L1 and L2 regularization, dropout, and weight decay can be applied to ensure that the model learns robust features while avoiding excessive sensitivity to the training data. These methods help the model maintain performance across different tasks and datasets, improving its ability to generalize from new, unseen data.

The architectural adjustments involve modifying the structure or configuration of the model itself, such as adding or removing layers, neurons, or connections based on ongoing performance and data. This approach can include dynamic network expansion or contraction, allowing the model to adapt its capacity according to the complexity of the task or data. Architectural adjustments can help the model better capture relevant features and improve its adaptability to new data.

The memory or data replay methods involve storing and replaying past data or experiences to maintain a comprehensive understanding of previously learned information. Techniques such as experience replay, episodic memory, and rehearsal strategies enable the model to retain and leverage knowledge from past interactions, reducing the impact of catastrophic forgetting and enhancing the model's ability to generalize across different tasks.

The continual learning framework 204 supports both unsupervised and supervised updates. Initially, the framework performs unsupervised updates using only the inputs specific to generated experiments, without requiring real data specific to the outputs. This approach helps the prediction model 202 to adjust to noise and uncertainties in system parameters. Subsequently, supervised updates are performed using data generated and measured from real experiments for further refining the prediction model accuracy.

The optimization component 206 is responsible for iteratively optimizing the curing process based on feedback from predictions, simulations and real-world experiments. The simulations are virtual experiments conducted using computational models to predict the behavior and outcomes of the curing process under various conditions. The simulations may replicate different scenarios that might be too expensive, time-consuming, or impractical to perform physically. The simulation feedback allows for quick initial testing and broad exploration of the parameter space. The prediction model 202 may be calibrated against these virtual experiments to ensure it aligns with theoretical expectations.

Simulations consider multiple parameters and variables, such as temperature profiles, pressure variations, material properties, and environmental conditions. These variables may be adjusted to observe their impact on the curing process. Data generated from simulations may include:

Thermal Profiles: Information about how the composite material temperature changes over time and how it affects the curing of the composite material.

Stress and Strain Analysis: Predictions of how the material behaves under different stress conditions during the curing process.

Degree of Cure: Simulations may predict the extent to which the composite material has cured at various stages of the process.

The advantages of simulation feedback may include running simulations is generally less expensive than conducting physical experiments. Further, simulations may be performed quickly, allowing for rapid iteration, and testing of different scenarios. Furthermore, Simulations can predict potentially hazardous conditions without risking physical damage or safety.

Apart from simulations, the physical experiments involve actual curing processes performed in controlled environments such as laboratories or manufacturing facilities. Real-world experiments provide empirical data that reflect the actual behavior of the materials and processes. Various sensors are used to collect data on temperature, pressure, humidity, and other relevant parameters during the curing process. Data generated from the real-world experiments may include:

Temperature Measurements: Actual temperature profiles recorded throughout the curing process.

Material Properties: Observations of changes in material properties such as hardness, tensile strength, and flexibility after curing.

Quality Metrics: Measurements of the final product quality, including the presence of defects, uniformity of curing, and adherence to desired specifications.

The advantages of real-world experiments feedback include, it provides empirical data that is representative of real-world conditions, ensuring the model's predictions are grounded in reality. Further, it helps validate and calibrate simulation models, ensuring their predictions are accurate and reliable. Moreover, it may reveal unexpected behaviors or outcomes that simulations might not predict.

Therefore, the optimization component works in conjunction with the prediction model 202 and the continual learning framework 204 to refine the curing process parameters and achieve optimal results. The optimization component employs genetic algorithms or linear programming to find the best curing process configurations that meet the desired objectives.

The optimization process aims to achieve the best curing degree or curve, considering constraints such as physics-related properties and decision variables like material composition, dimensions, and air temperature, all within specified ranges. By iteratively updating the optimization parameters based on real-time feedback, the system 100 ensures that the curing process is continuously improved and fine-tuned.

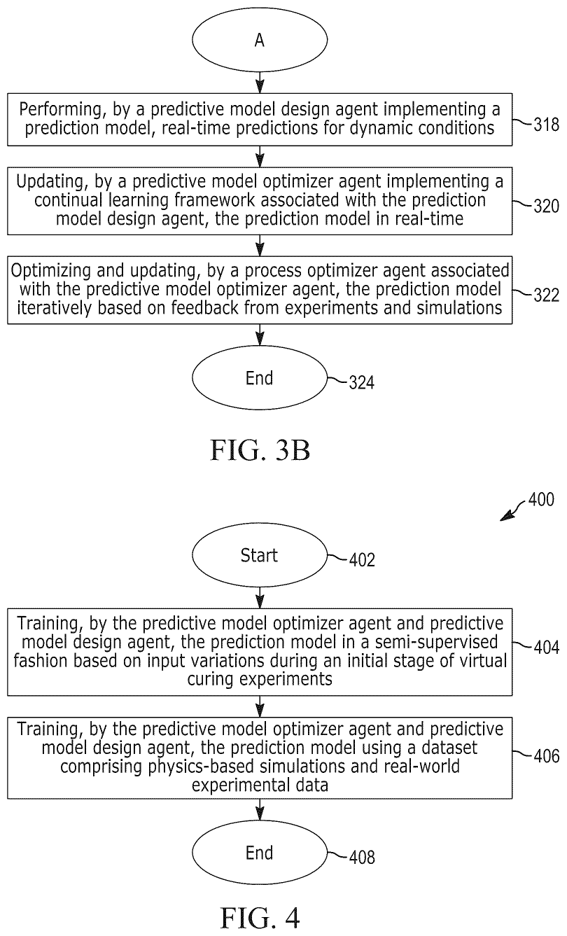

FIGS. 3A and 3B illustrate a flow diagram of a method 300 for designing curing processes, in accordance with an example embodiment. It will be understood that each block of the flow diagram of the method 300 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 300 illustrated by the flow diagram of FIG. 3A for designing curing processes may start at step 302. Further, the method 300 may include obtaining design requirements using a requirement gathering agent, at step 304.

Further, the method 300 may include determining potential ranges of recipes and operating conditions with an operations specialist agent based on the obtained design requirements, material options, and design options, at step 306.

Further, the method 300 may include identifying suitable material options and assessing corresponding properties with a material specialist agent to meet design objectives, at step 308.

Further, the method 300 may include defining dimensions and shape aspects of the design using a design specialist agent based on the gathered requirements, material options, and operating conditions, at step 310.

Further, the method 300 may include extracting and reasoning relevant information specific to design, operation, and materials with a knowledge processing and retrieval agent, at step 312.

Further, the method 300 may include formulating a final requirement specification with an experiment enabler agent, at step 314.

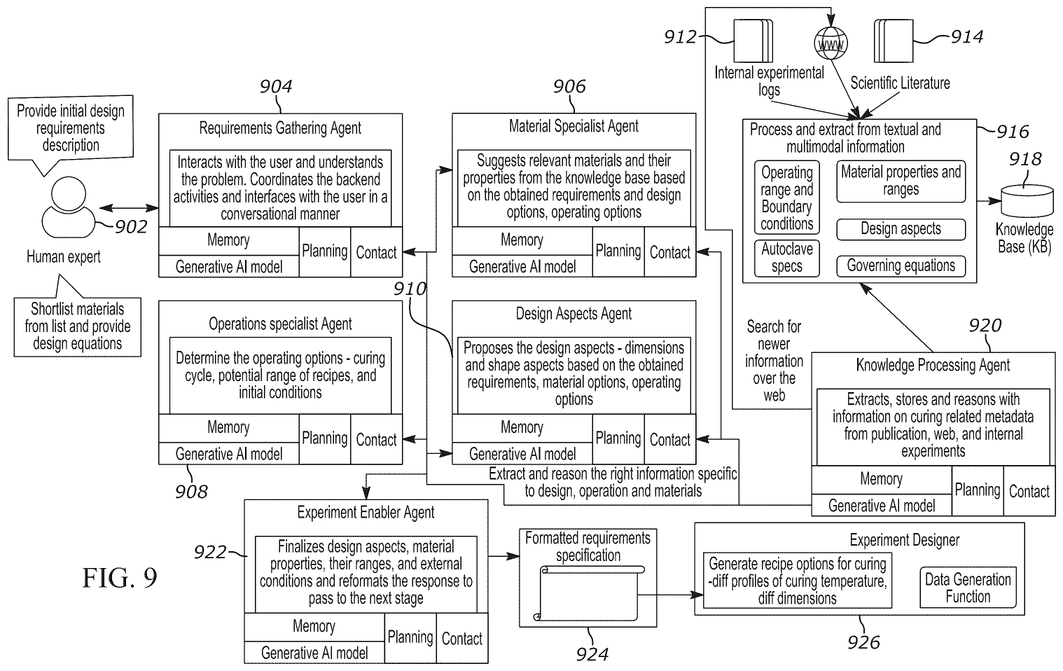

Further, the method 300 may include generating a first set of experiments based on the final requirement specifications using an experiment designer, at step 316. The complete process is further explained in detail in conjunction with FIGS. 8A and 8B.

Referring now to FIG. 3B, the method 300 may further include performing, by a predictive model design agent implementing a prediction model, real-time predictions for dynamic conditions, at step 318. The dynamic conditions may be various real-time variables that may affect the curing process, such as changes in temperature, pressure, humidity, and material properties.

The prediction model used is a Physics Informed Neural Operator (PINO) model. This model utilizes both physics-based principles and data-driven approaches to make accurate predictions under varying conditions. The PINO model is capable of real-time predictions, providing information of how the curing process may evolve based on current and expected conditions.

The method 300, at step 320, may include updating, by a predictive model optimizer agent implementing a continual learning framework associated with the prediction model design agent, the prediction model in real-time. The real-time updates are facilitated by a continual learning framework associated with the prediction model. This is crucial for maintaining the accuracy of predictions as new data becomes available or as conditions change. This framework enables the prediction model to learn continuously from new data, improving its predictive capabilities over time. Techniques employed may include online gradient descent, Bayesian optimization, and reinforcement learning.

At step 322, the method 300 may include, optimizing and updating, by a process optimizer agent associated with the predictive model optimizer agent, the prediction model iteratively based on feedback from experiments and simulations. Feedback from predictions, physical experiments and simulation results are used to refine the prediction model. This feedback loop ensures that the prediction model stays relevant and accurate, adjusting to new information as it is obtained. The optimization component associated with the prediction model optimizer agent performs this iterative process. The component applies optimization algorithms, such as genetic algorithms or linear programming, to fine-tune the model parameters for better performance. Further, the method 300 terminated at step 324.

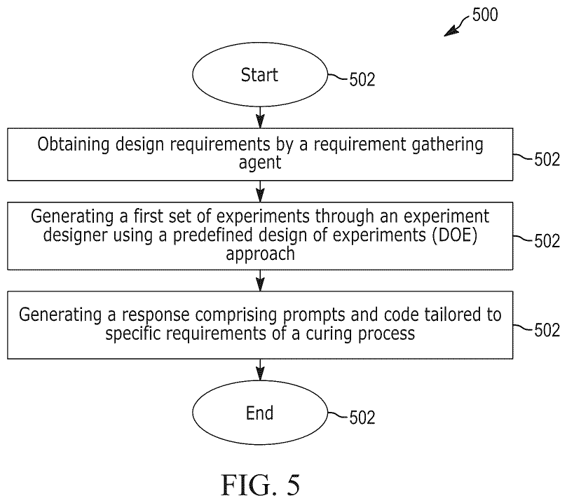

FIG. 4 illustrates a flow diagram of a method 400 for pre-training the prediction model, in accordance with an example embodiment. It will be understood that each block of the flow diagram of the method 400 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

FIG. 4 is explained in conjunction with elements from FIGS. 1, 2, and 3. As explained earlier, the prediction model is the PINO model and is the pre-trained model. The present FIG. 4 illustrates the method 400 for pre-training the PINO model.

At step 402, the method 400 is initiated. The method 400, at step 404 may include training, by the predictive model optimizer agent and predictive model design agent, the prediction model in a semi-supervised fashion based on input variations during an initial stage of virtual curing experiments. The prediction model is exposed to a wide range of input parameters, such as different temperature, pressure conditions, material properties, and geometrical configurations. This helps in understanding how variations in inputs affect the curing process.

During this stage, the prediction model is not fully supervised. Instead, it uses initial input data to make predictions and gradually learns from the outcomes of these virtual experiments. The semi-supervised approach allows the prediction model to iteratively improve its predictions by adjusting based on the feedback it receives from the virtual experiments. The semi-supervised learning allows the model to improve without requiring a complete dataset of labeled outcomes, making the process more efficient.

Further, the method 400, at step 404, may include training, by the predictive model optimizer agent and predictive model design agent, the pre-trained model using a dataset comprising physics-based simulations and real-world experimental data.

Physics-based simulations use mathematical models and physical laws to predict the curing process under various conditions. The data generated from these simulations include temperature profiles, pressure conditions, material responses, and alike.

Real-world experimental data is gathered from actual experiments conducted in controlled environments. It includes empirical measurements such as actual temperature changes, material property variations, and outcomes of different curing cycles. The prediction model is trained on this combined dataset to ensure it captures both the theoretical and practical aspects of the curing process. This dual approach helps in making the prediction model robust and reliable. By training on diverse data sources, the prediction model may make more accurate predictions. The method 400 ends at step 408.

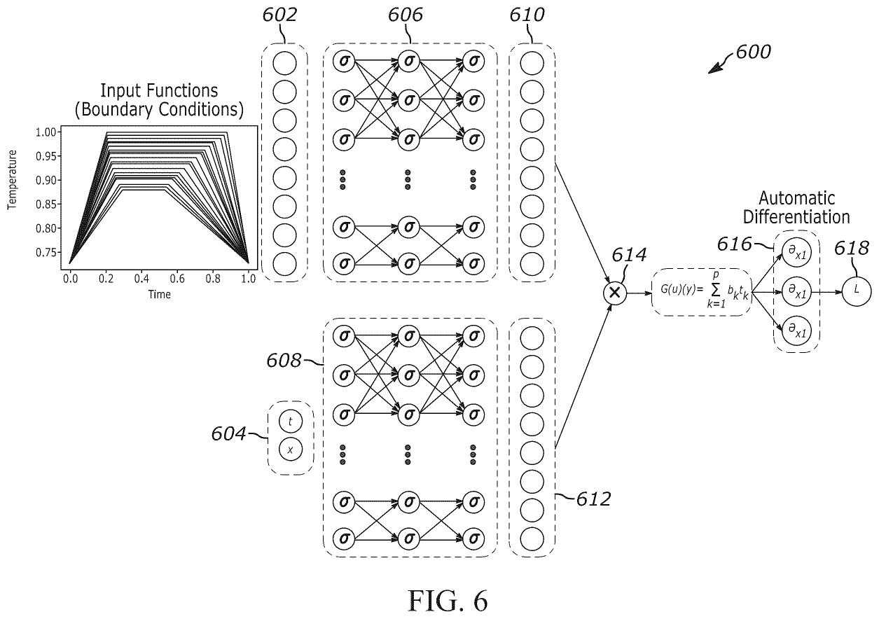

FIG. 5 illustrates a flow diagram of a method 500 for generating a first set of experiments, in accordance with an example embodiment. It will be understood that each block of the flow diagram of the method 500 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

FIG. 5 is explained in conjunction with elements from FIGS. 1, 2, 3, and 4. The method 500 is started at step 502. Therefore, generating the first set of experiments, at step 504, may include obtaining experimental design tasks and material specifications using the requirement gathering agent. The experimental design tasks includes defining the objectives of the experiments, identifying key variables, and determining the scope of the experiments. Additionally, material specifications may include information about the materials to be used in the curing process, including their properties, expected behavior, and any constraints.

Upon obtaining experimental design tasks and material specifications, the method 500, at step 506 may further include generating a first set of experiments (curing experiment) through an experiment designer using a predefined design of experiments (DOE) approach. During the initial stage, the experiment designer is set to “explore” the whole search space to get diverse and comprehensive data.

In other words, the set of virtual curing experiments is generated, exploring the entire search space using methods such as the Taguchi design or full factorial designs. This ensures that the model is trained with diverse data points, covering all possible variations in input parameters like temperature regime, air flow conditions, material options, and part dimensions.

Traditional DOE methodologies, like the Taguchi method, provide structured approaches for designing experiments. However, this method may lack the flexibility to adapt to unique and specific requirements of complex curing processes. The Gen AI may fill this gap by generating tailored structural prompts that align with the intricacies of the specific curing process. The method 500, at step 508 may further include generating, through the Gen AI, a response comprising prompts and code tailored to specific requirements of a curing process. The term structural prompt refers to a detailed and structured set of instructions or guidelines generated by the Gen AI to aid in the design of experiments. These prompts are tailored to address the specific needs and conditions of the curing process, ensuring that the experiments are relevant and effective. For instance, the Gen AI may generate prompts that suggest specific temperature ranges, air flow rates, or material combinations to be tested in the experiments. The Gen AI helps in optimizing the design by suggesting modifications, improvements, or alternative approaches based on the input data and predefined objectives. By automating the experiment design process, Gen AIs reduce the dependency on human expertise, accelerate the design cycle, and ensure that the experiments cover a comprehensive range of conditions.

In the early stages, the experiment designer focuses on exploring the search space to gather comprehensive training data. As iterations progress, the focus shifts to exploiting the best-known regions of the search space, reducing the number of experiments while pointing in on optimal conditions. After each iteration, the prediction model is updated based on the results of the latest experiments. The number of real experiments is kept manageable, typically between 10-20, while virtual experiments may be in the thousands. This iterative process continues until the model achieves satisfactory accuracy, balancing exploration with exploitation.

The Gen AI analyzes the current model performance, such as the trajectory of the loss, along with the current parameters related to both the process and the model architecture. Based on this analysis, the Gen AI suggests improvements or modifications to either the training strategy or the design decisions. This dynamic approach ensures that experimental designs evolve and improve with each iteration, leading to progressively better optimization of the curing process. The method 500 terminates at step 510 when the model achieves a satisfactory level of accuracy, balancing the need for comprehensive exploration with efficient exploitation.

The integration of Gen AI in the design of curing processes brings significant advancements, particularly through the generation of structured prompts. One of the primary advantages is efficiency gained through automation. By utilizing the Gen AI, the experiment design process is significantly accelerated. This not only speeds up the design cycle but also minimizes the time and resources typically required for manual experiment design. Consequently, researchers and engineers may achieve their objectives more quickly, allowing for faster iterations and quicker implementation of optimized curing processes. The automation provided by the Gen AI also minimizes the dependency on human expertise, making the process more accessible to a broader range of users.

Another advantage of Gen AI-generated structured prompts is the comprehensiveness it offer in experimental design. During the initial stages, the Gen AI aids in determining the lower and upper bounds for ranges of selected design variables through interaction with the user. Once these ranges are finalized, predefined Design of Experiments (DOE) techniques, such as the Taguchi method, are used to create structured experimental plans. This approach ensures that the prediction model is trained with a wide array of data points, covering all possible variations in input parameters such as temperature ranges, air flow conditions, material options, and part dimensions. By capturing this wide range of data, the prediction model may make more accurate predictions, leading to better informed decisions and more robust process designs.

Further, the relevance of the experiments is greatly enhanced through Gen AI-generated structured prompts. These prompts are specifically designed to address the unique needs and conditions of the curing process under consideration. By suggesting specific temperature ranges, air flow rates, or material combinations, the Gen AI ensures that the experiments are not only diverse but also highly pertinent to the curing process. This approach leads to more effective optimization, as the experiments are directly aligned with the specific requirements and objectives of the curing process.

Additionally, iterative improvement is a crucial aspect of the Gen AI-enhanced experimental design process. As the experiment designer progresses through iterations, the focus shifts from exploring the search space to exploiting the best-known regions. This iterative process involves continuously updating the prediction model based on the latest experimental results, leading to ongoing refinements and improvements. The dynamic responses generated by the Gen AI, which include both prompts and code for model design and optimization, ensures that each set of experiments builds on the previous one, progressively pointing towards the optimal conditions. This approach ensure that the curing processes are optimized in a resource-efficient manner, leading to better outcomes and faster implementation of optimized solutions.

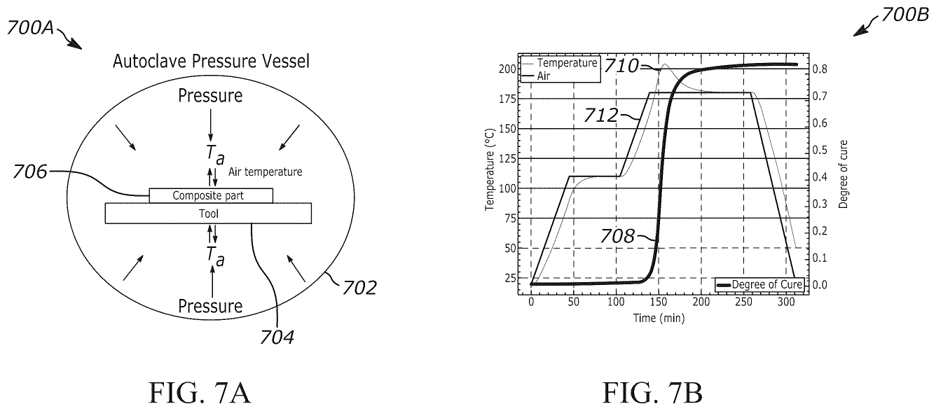

FIG. 6 illustrates an exemplary architecture 600 of the prediction model utilized in designing curing processes, in accordance with an example embodiment. The present FIG. 6 provides a detailed view of the neural network components and their interconnections, highlighting the role of each part in processing input functions and generating accurate predictions under dynamic conditions.

Referring to FIG. 6, input functions 602 is depicted. These inputs include boundary conditions essential for the curing process, such as temperature profiles over time. The graph shown represents how these input functions vary, providing crucial data that influences the subsequent neural network computations. Below the input functions 602, temporal (t) and spatial (x) inputs 604 are indicated. These inputs represent the specific times and positions within the curing environment, which are vital for understanding the dynamic behavior of the materials being processed.

The present architecture 600 further includes two sets of neural networks. A first set of neural networks 606 processes the input functions 602. These networks are designed to handle complex relationships within the boundary conditions and extract meaningful patterns that may influence the model predictions. Additionally, a second set of neural networks 608 processes the temporal and spatial inputs 604. These networks focus on understanding how the curing process evolves over time and across different spatial locations.

Both sets of neural networks i.e., the first set of neural networks 606 and the second set of neural networks 608 generate intermediate outputs 610 and 612. These outputs represent the processed information from the input functions and the temporal/spatial inputs, respectively. These intermediate outputs are critical as they capture the transformed data ready for further integration.

The outputs from the two sets of neural networks are then combined through a multiplication operation 614. This operation integrates the processed boundary conditions with the temporal and spatial data, allowing the model to synthesize a comprehensive understanding of the curing process.

Following the combination, the integrated data is passed through a component for automatic differentiation 616. This step involves calculating gradients with respect to various parameters, which is crucial for the optimization and continual learning processes. The differentiation helps in refining the model parameters (θ) iteratively.

Finally, the prediction model incorporates a loss function 618, depicted as a node with the symbol “L”. The loss function 618 evaluates the accuracy of the model's predictions by comparing them to actual experimental results or desired outcomes. By minimizing this loss, the prediction model may adjust its parameters to improve prediction accuracy. Therefore, the exemplary architecture 600 of the prediction model 600, showcasing how input functions 602, temporal and spatial inputs 604, and neural networks (606 and 604) computations come together to generate accurate predictions for the curing process. Each component from the initial input processing to the final loss calculation plays a vital role in ensuring the prediction model robustness and adaptability under dynamic conditions. This architecture 600 enables the system to learn continuously and optimize curing processes efficiently.

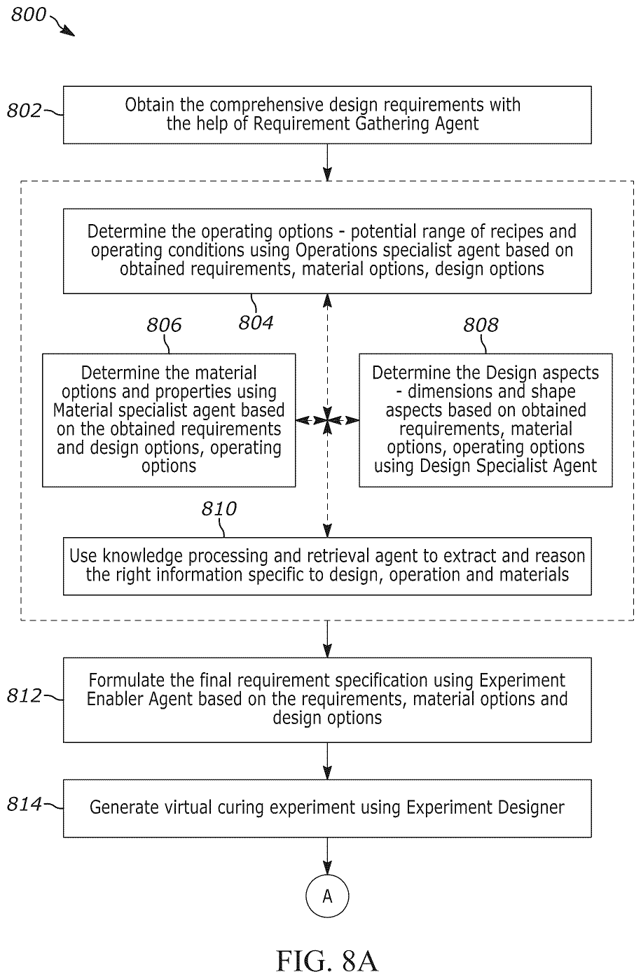

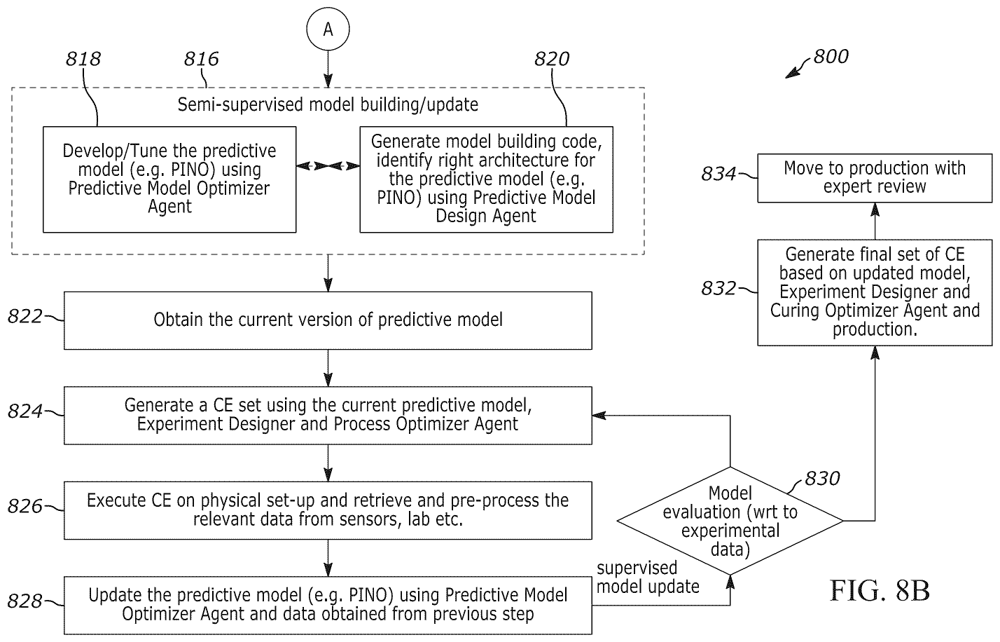

FIG. 7A illustrates an exemplary autoclave setup 700A for composite materials, in accordance with an example embodiment. The present FIG. 7A depicts autoclave pressure vessel setup. The autoclave setup 700A includes an autoclave pressure vessel 702. The autoclave pressure vessel 702 is a controlled environment where the curing process takes place. It is designed to apply both heat and pressure to the composite part to ensure proper curing.

In a more elaborative way, the process begins with an initial heating phase where the temperature inside the autoclave is gradually increased. This phase ensures that the composite material reaches the necessary temperature to start the curing reaction.

After reaching the target temperature, the soak phase maintains a constant temperature for a specified duration. This phase allows the curing reaction to proceed steadily, ensuring uniform curing throughout the composite part.

Following the soak phase, the temperature is gradually decreased in a controlled cooling phase. This prevents thermal stresses and potential warping or cracking in the composite part. Throughout the process, the temperature and pressure inside the autoclave are closely monitored and controlled to adhere to the predefined profiles. Any deviations may be corrected in real-time to ensure optimal curing conditions.

Inside the autoclave 702, a composite part 706 is placed on a tool 704 that supports it during the curing process. The composite part is the material undergoing the curing, typically made from layers of fabric and resin. The autoclave controls air temperature (Ta) around the composite part. The temperature is a critical parameter in the curing process, influencing the chemical reactions that occur within the composite material. The autoclave applies pressure from all directions (as indicated by the arrows). The pressure ensures that the composite layers are compacted properly, removing any air bubbles, and ensuring uniform resin distribution. The present example emphasizes a necessity of precise control and monitoring to achieve the desired material properties in the final composite part.

FIG. 7B illustrates a corresponding temperature and degree of cure profiles 700B over time for the autoclave setup 700A, in accordance with an example embodiment. In particular, the present FIG. 7B depicts dynamic temperature and degree of cure profiles, illustrating how the curing process evolves over time.

The temperature profile 708 represents the air temperature inside the autoclave over time. This profile shows how the temperature is increased, held constant, and then decreased in a controlled manner. The air temperature profile 710 indicates the actual temperature of the air inside the autoclave, which is closely monitored and controlled to follow the desired temperature profile. The degree of cure profile 712 tracks the progress of the curing process over time. The degree of cure is a measure of how completely the resin has polymerized and cross-linked, which is crucial for the final properties of the composite part.

As will be appreciated by those skilled in the art, the techniques described in the various embodiments discussed above are not routine, or conventional, or well understood in the art. The techniques discussed above provide for innovative solutions to address the challenges associated with designing the curing process. The disclosed techniques offer several distinct advantages that enhance the efficiency, accuracy, and reliability of curing composite materials.

The disclosed techniques incorporate a pre-trained hybrid neural operator model, which is capable of real-time predictions for dynamic conditions. This approach offers several benefits:

Adaptive Learning: The continual learning framework employs advanced techniques such as online gradient descent, Bayesian optimization, and reinforcement learning. These methods allow the model to continuously learn from new data, improving its performance over time.

Real-Time Updates: The framework supports real-time updates, ensuring that the model remains current with the latest experimental data and evolving process conditions. This reduces the need for periodic retraining and minimizes downtime.

The optimization component iteratively refines the curing process based on feedback from simulations and real-world experiments:

Feedback Integration: by integrating feedback from both virtual simulations and actual experiments, the optimization component ensures that the model is validated against real-world scenarios. This dual-source feedback loop enhances the robustness of the model.

Iterative Refinement: The use of techniques such as genetic algorithms and linear programming for optimization allows for continuous improvement of the curing process, targeting the best possible curing degree or curve within defined constraints.

The experiment designer that utilizes the Gen AI, plays a crucial role in generating and optimizing experiments. For example, during the initial stages, the experiment designer explores the entire search space using DOE techniques such as Taguchi methods. This comprehensive approach ensures that the model receives diverse and representative training data.

Further, the Gen AI generates structured prompts tailored to specific curing process requirements, optimizing the design of experiments, and ensuring that all critical variables are considered. Further, by focusing on the most promising areas of the search space in subsequent iterations, the number of required experiments is significantly reduced, lowering costs and resources.

The disclosed techniques also supports semi-supervised training and efficient resource management. For example, the prediction model is initially trained in a semi-supervised fashion using virtual curing experiments. This approach leverages input variations to generate valuable training data without the need for extensive real-world experimentation.

Further, a dedicated resource management module ensures optimal allocation of resources for training, experimental design, and optimization tasks, enhancing the overall efficiency of the system.

The system includes the GUI that facilitates user interaction. For example, the GUI allows users to input design parameters, visualize optimization results, and receive feedback. This interactive interface improves user experience and aids in decision-making. Moreover, visualization tools within the GUI provide clear and intuitive information of the curing process, helping users understand the impact of different variables and adjustments.

FIGS. 8A and 8B illustrate an exemplary workflow 800 for Gen AI-assisted composite curing designer, in accordance with an example embodiment. The present FIGS. 8A and 8B depict various agents useful for designing curing processes. At step 802, comprehensive design requirements is obtained with the help of a Requirement Gathering Agent. In this initial step, the Requirement Gathering Agent is employed to compile a comprehensive list of design requirements. This involves gathering all necessary information and specifications needed for the design process.

At step 804, the operating options is determined. An Operations Specialist Agent is tasked with determining the potential range of recipes and operating conditions based on the obtained requirements, material options, and design options. This step involves analyzing various operating parameters and conditions that could affect the design. The agent evaluates different combinations and possibilities to identify the most suitable operating scenarios that align with the project requirements.

At step 806 the material options and properties may be determined. At this stage, a Material Specialist Agent plays a crucial role in identifying suitable material options and their properties. Using the obtained requirements and design options, the agent evaluates various materials to determine their compatibility with the design objectives. This includes assessing the materials' physical, chemical, and mechanical properties to ensure they meet the necessary standards and criteria for the project.

At step 808, the design aspects may be determined. A Design Specialist Agent is responsible for determining the dimensions and shape aspects of the design based on the obtained requirements, material options, and operating options. This step involves defining the geometric and structural characteristics of the design. The agent uses the collected data to develop a detailed and precise design that fulfils the specified requirements and constraints.

At step 810, a knowledge processing and retrieval agent may be utilized. In this step, the Knowledge Processing and Retrieval Agent is used to extract and reason the right information specific to design, operation, and materials. The agent leverages advanced data processing and retrieval techniques to gather relevant knowledge and insights. This information is then used to support the decision-making process, ensuring that the design, material selection, and operating conditions are well-informed and optimized.

At step 812, the final requirement specification may be formulated. An Experiment Enabler Agent formulates the final requirement specification based on the gathered requirements, material options, and design options. This involves consolidating all the information into a comprehensive and coherent specification document. The agent ensures that the final requirements are clearly defined and accurately reflect the project's objectives and constraints.

At step 814, virtual curing experiment may be generated. Finally, the Experiment Designer uses the formulated requirement specifications to generate a virtual curing experiment. This step involves creating a simulated environment to test and validate the design under various conditions. The virtual curing experiment allows for the assessment of the design's performance and behavior, providing valuable information and data that can be used to refine and optimize the design further.

Now referring to FIG. 8B, at step 816 semi-supervised model building/update may take place. In this phase, the predictive model (e.g., PINO) is developed or tuned using a Predictive Model Optimizer Agent. This involves adjusting and refining the model to improve its accuracy and performance based on the specific requirements and constraints of the project.

At step 818, the predictive model may be developed or tuned. The Predictive Model Optimizer Agent is responsible for developing or tuning the predictive model (e.g., PINO). This step includes optimizing the model's parameters and algorithms to enhance its predictive capabilities. The agent uses data from previous experiments and simulations to fine-tune the model.

At step 820, model building code may be generated and the right architecture may be identified. The Predictive Model Design Agent generates the necessary code for building the model and identifies the appropriate architecture for the predictive model (e.g., PINO). This involves selecting the best structure and configuration for the model to ensure optimal performance and accuracy.

At step 822, the current version of the predictive model may be obtained. The current version of the predictive model is obtained and reviewed. This step ensures that the latest model version is used for further development and testing.

At step 824, a set of curing experiments (CE) may be generated using the current predictive model. Using the current predictive model, along with the Experiment Designer and Process Optimizer Agent, the CE set is generated. This involves designing experiments to validate and test the predictive model under various conditions.

At step 826, the CE on physical set-up may be executed. The CE set is executed on the physical setup, and relevant data is retrieved and pre-processed from sensors, lab equipment, and other sources. This step collects experimental data that will be used to evaluate and refine the predictive model.

At step 828, the predictive model may be updated. The predictive model (e.g., PINO) is updated using the Predictive Model Optimizer Agent and the data obtained from the previous step. This involves incorporating the new data into the model to improve its accuracy and reliability. At step 830, an evaluation of the predictive model with respect to experiment data may take place. Step 830 may involve an iterative procedure where steps, if the evaluation is not found to be satisfactory, steps 824 to 830 are repeated until the evaluation criteria are met.

At step 832, a final set of CE may be generated. The final set of CE is generated based on the updated model, the Experiment Designer, and the Curing Optimizer Agent. This step involves designing the final experiments and procedures for curing composites in production, ensuring that all parameters and conditions are optimized for the best results.

At step 834, move to production with expert review. Once the predictive model has been updated and validated, it is moved to production with an expert review. This step ensures that the model meets all necessary standards and is ready for practical application.

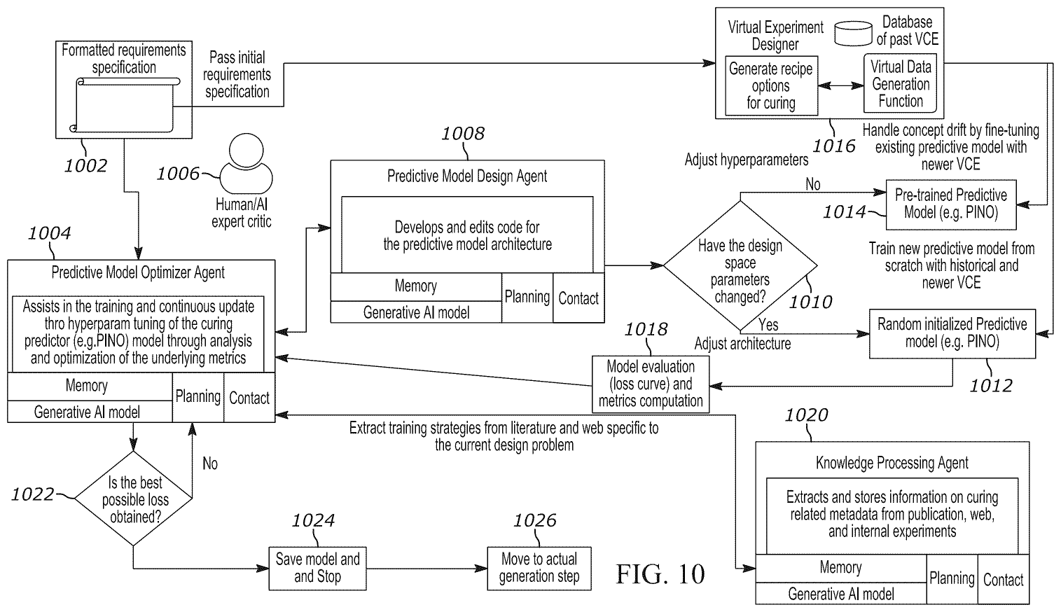

FIGS. 9 illustrate a detailed block diagram for Gen AI-assisted composite curing designer, in accordance with an example embodiment. The present FIG. 9 shows a comprehensive workflow involving various agents and components to optimize the design and curing process.

A human expert 902 provides the initial design requirements description, including a shortlist of materials and relevant design equations. The human expert input serves as the starting point for the entire design process, ensuring that the system's initial parameters align with practical and project-specific considerations.

A Requirements Gathering Agent 904 interacts with the human expert 902 to understand the problem comprehensively. This agent 904 coordinates backend activities and interfaces with the user in a conversational manner. A Material Specialist Agent 906 suggests relevant materials and their properties based on the obtained requirements and design options. This agent 906 uses a knowledge base to provide suitable material options that align with the project specifications, operating conditions, and design constraints.

An Operations Specialist Agent 908 determines the operating options, such as the curing cycle, potential range of recipes, and initial conditions. Using memory and generative AI models, this agent 908 analyzes different operational scenarios to identify the most effective and efficient operating parameters.

A Design Aspects Agent 910 proposes the design dimensions and shape aspects based on the obtained requirements, material options, and operating options. This agent 910 ensures that the design parameters are accurately defined to meet the project objectives.

Internal experimental logs 912 provide historical data and information from previous experiments. This data is crucial for validating and refining the design and operational parameters proposed by the agents.

A scientific literature 914 serves as a source of validated and peer-reviewed information on material properties, design aspects, operating conditions, and governing equations. This information is used to inform and enhance the decision-making process.

Process and extract from textual and multimodal information 916 involves processing and extracting relevant information from textual and multimodal sources, including internal logs and scientific literature. The extracted data includes operating ranges, boundary conditions, material properties, design aspects, and autoclave specifications, which are then stored in the knowledge base.

A knowledge base (KB) 918 stores all the processed and extracted information, providing a centralized repository of relevant data. This knowledge base is accessed by various agents to inform their decision-making processes.

A Knowledge Processing Agent 920 extracts, stores, and reasons with information on curing-related metadata from publications, the web, and internal experiments. This agent uses memory and generative AI models to provide accurate and relevant information specific to design, operation, and materials.

An Experiment Enabler Agent 922 finalizes the design aspects, material properties, their ranges, and external conditions. It reformats the response to ensure it is ready for the next stage of the process. This agent 922 plays an important role in ensuring that all design parameters are well-defined and optimized for the subsequent experimental phase.

A formatted requirements specification 924 is a comprehensive document that consolidates all the design, material, and operational parameters. This document 924 serves as a blueprint for the experimental design and subsequent validation processes.

The Experiment Designer 926 generates recipe options for curing, including different profiles of curing temperature, diffusion dimensions, and other relevant parameters. This designer 926 uses a data generation function to simulate various curing scenarios and identify the optimal conditions for the composite curing process.

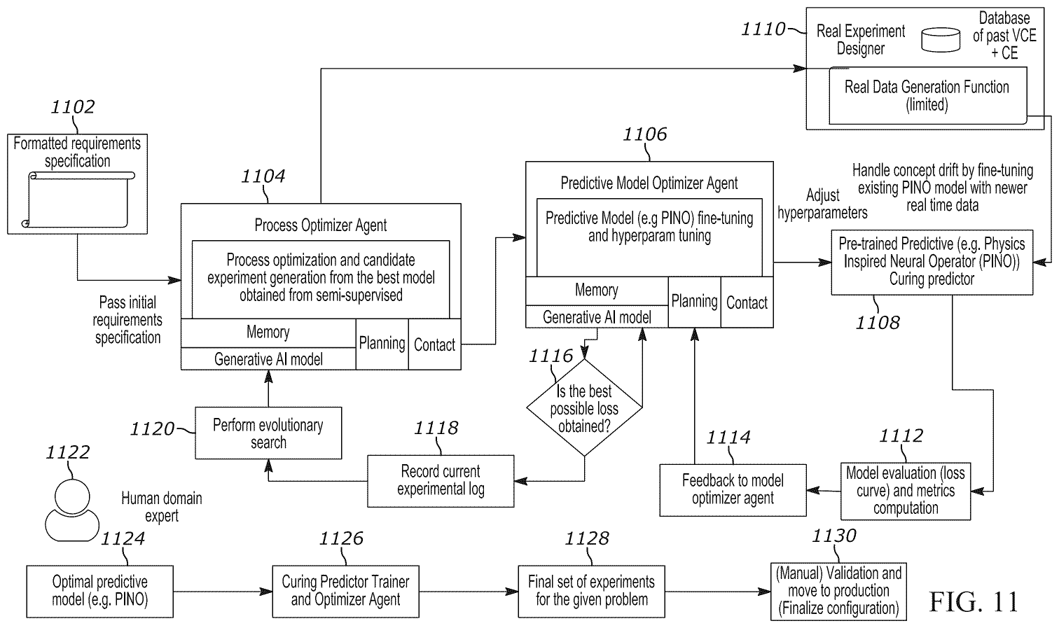

FIG. 10 illustrate an exemplary block diagram for a semi supervised update (pre-trained) curing predictor model without real experiment data, in accordance with an example embodiment. The process begins with a formatted requirements specification 1002 (analogous to the formatted requirements specification 924). This initial set of requirements is prepared and passed on to the subsequent stages to guide the model development and optimization processes.

A Virtual Experiment Designer 1016 generates recipe options for curing, using a database of past VCE data. It provides the necessary virtual experiment data to train and fine-tune the predictive models.

A Predictive Model Optimizer Agent 1004 assists in the training and continuous update of the curing predictor model, specifically focusing on hyperparameter tuning through analysis and optimization of underlying metrics. It interacts closely with a Predictive Model Design Agent 1008 and other components to ensure the model's performance meets the desired criteria.

Both human experts and AI systems 1006 collaborate to critique and guide the model's development. They ensure the process aligns with the specified requirements and provide feedback to refine the model.

The Predictive Model Design Agent 1008 is responsible for developing and editing the code for the predictive model architecture. It integrates memory, planning, generative AI models, and contact functions to construct a robust model design that meets the specified requirements.

At this decision stage 1010, the process evaluates whether the design space parameters have changed. If they have, the architecture is adjusted, otherwise, only hyperparameters are tuned.

If the design space parameters have not been changed, then the process moves towards a Pre-trained Predictive Model (e.g., PINO) 1014 that represents the pre-trained model, which can handle concept drift by fine-tuning the existing predictive model with newer virtual curing experiment (VCE).

If the design space parameters have changed, then the process moves to a Random initialized Predictive Model (e.g., PINO) 1012. In this step, a new predictive model is trained from scratch using both historical and newer VCE data, representing a completely random initialization to adapt to new requirements or significant changes in design parameters.

Further, a model evaluation (loss curve) and metrics computation 1018 may take place. The model's performance is evaluated by computing the loss curve and other relevant metrics. This step is important for understanding how well the model performs and identifying areas for further improvement.

A Knowledge Processing Agent 1020 extracts and stores information related to curing from various sources, including publications, web data, and internal experiments. It supports the training process by providing relevant metadata and knowledge that can be used to enhance the model. Training strategies are extracted from literature, web resources, and internal experiments specific to the current design problem. This knowledge aids in refining the model further.

Further, the process checks 1022 whether the optimal loss has been achieved. If not, the model continues to be optimized; otherwise, the process moves to the next step.

Once the optimal loss is obtained, the model is saved, and the training process is stop 1024. After the model is saved, it proceeds to the actual generation step 1026, where it will be used for practical applications.

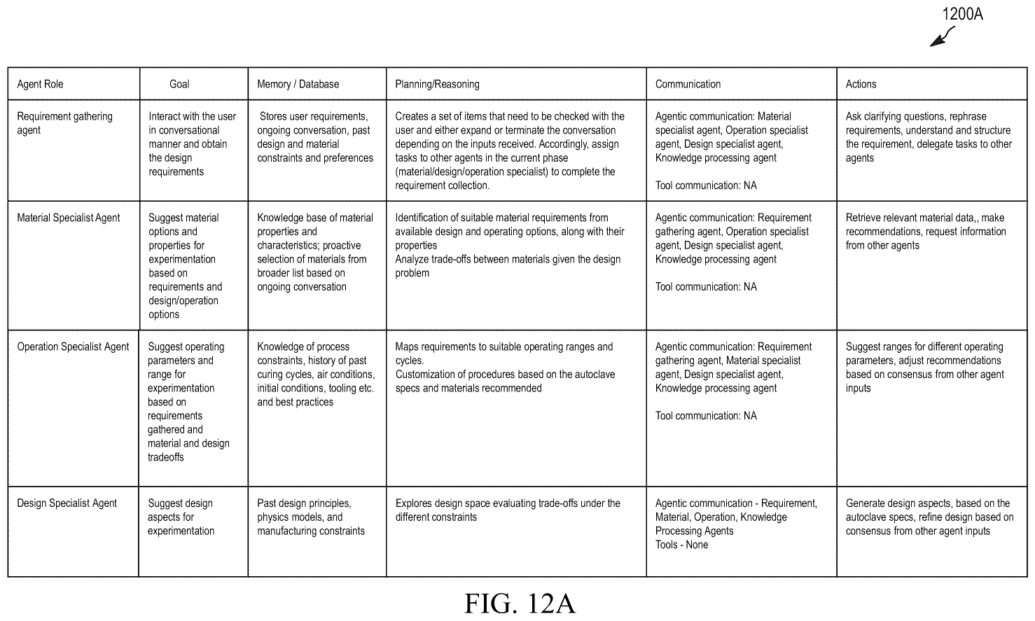

FIG. 11 illustrate an exemplary block diagram for a creating optimal curing experiments using a curing optimizer, in accordance with an example embodiment. The process starts with a formatted requirements specification 1102 that provides the initial guidelines and parameters for the optimization and experiment generation.

The initial requirements specification is passed to a Process Optimizer Agent 1104. This agent 1104 handles the optimization process and generates candidate experiments based on the best model obtained from a semi-supervised approach. It enables identification of best set of real experiments based on the latest predictive model. Additionally, it assists in manipulating (e.g. exploration-exploitation) the experiments based on the accuracy of the model and the current stage of the overall optimization cycle. It incorporates memory, planning, generative AI models, and contact functions to streamline the optimization.

The Predictive Model Optimizer Agent 1106 fine-tunes and tunes the hyperparameters of the predictive model (e.g., PINO). This ensures the model is continuously updated and optimized based on the latest data and requirements.

The Pre-trained Predictive Model 1108 represents the pre-trained model, such as the Physics Inspired Neural Operator (PINO) curing predictor. It handles concept drift by fine-tuning the model with newer real curing experiment data (rather than virtual experiment data). This fine-tuning process may include a subset of virtual curing experiment data (VCE) to stabilize the fine-tuning and prevent catastrophic forgetting of the curing predictor model.

The Real Experiment Designer 1110 generates real experimental data, supplementing VCE with real data to create a more robust and accurate model. This data is stored in a database for future reference.

The model performance is evaluated by computing the loss curve and other relevant metrics 1112. This step helps determine how well the model performs and identifies areas for further optimization.

The evaluation results are fed back 1114 to the Predictive Model Optimizer Agent 1106, which uses this information to adjust the model's hyperparameters and improve its performance.

The process checks 1116 whether the optimal loss has been achieved. If not, the model continues to be optimized, otherwise, it proceeds to the next steps.

The current experimental results and logs are recorded 1118 to keep track of the progress and provide a reference for future optimizations.

An evolutionary search is performed 1120 to explore different model configurations and identify the best possible solution for the given problem.

To further elaborate the process, initially, a human domain expert 1122 reviews the optimized model and the results from the evolutionary search to ensure they meet the desired criteria and make any necessary adjustments. The optimal predictive model 1124 is identified and finalized based on the evaluations and expert review. Further, the Curing Predictor Trainer and Optimizer Agent 1126 finalizes the set of experiments for the given problem, ensuring they are optimized and ready for validation. Further, the Final set of experiments for the given problem is prepared 1126, incorporating all the optimizations and adjustments made during the process. The final step involves manual validation of the experiments and moving the optimized model and experiments to production 1130. The configuration is finalized to ensure the model is ready for practical applications.

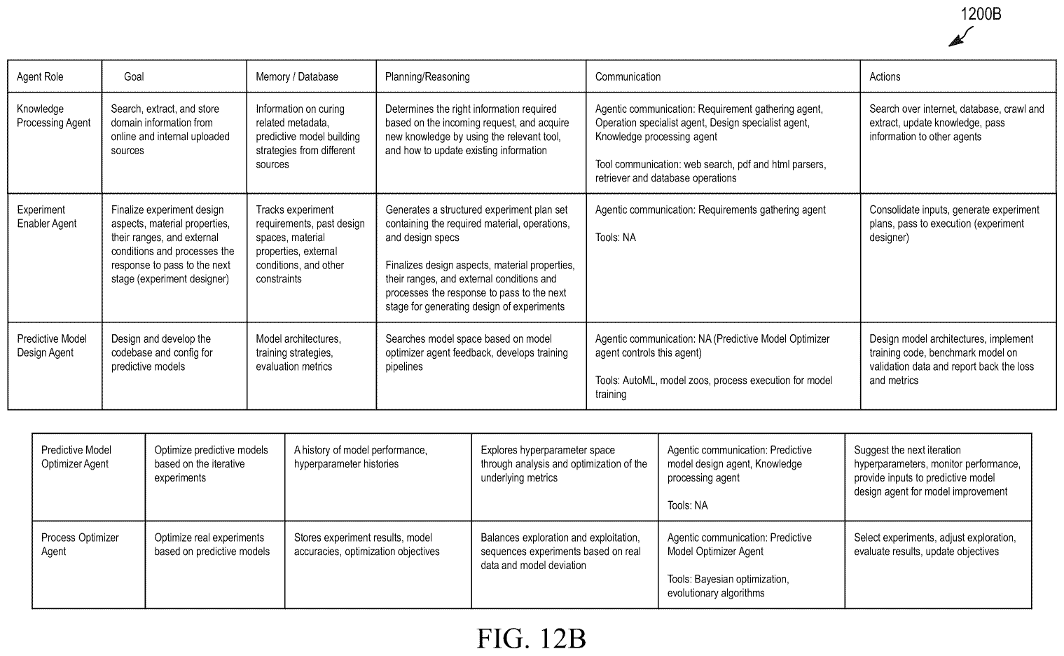

FIGS. 12A and 12B illustrate tables depicting different types of agents and their roles in designing curing processes, in accordance with an example embodiment. The present FIGS. 12A and 12B are explained in conjunction with FIGS. 9, 10, and 11.

Referring to FIG. 12A and 12B illustrate tables (1200A and 1200B) depicting Role, Goal, Memory/Database, Planning/Reasoning, Communication, and Actions of various agents for designing curing processes.

Requirement Gathering Agent: This agent acts as the bridge between the user and the design process. Its main goal is to thoroughly understand the user's needs and specifications for the design. It accomplishes this by:

Memory/Database: Storing information about user requirements, past conversations, and design constraints. It likely has access to a database with material properties and user preferences.

Planning/Reasoning: This agent can ask clarifying questions, rephrase user requirements for better understanding, and even delegate tasks to other agents to gather specific details.

Communication: It primarily interacts with the user through various communication channels to ensure clear and complete requirement capture.

Actions: This agent can prompt users for specific details, rephrase unclear requirements, and delegate tasks to other agents for further data collection.

Material Specialist Agent: This agent focuses on suggesting suitable materials for the design based on the user requirements and the evolving design itself. Its goal is to identify appropriate materials for the project.

Memory/Database: This agent possesses a comprehensive knowledge base of material properties and characteristics. It likely has access to a database containing information on strength, weight, cost, and other relevant material parameters.

Planning/Reasoning: It analyzes the design problem, user requirements, and operational needs to identify materials that meet all the necessary criteria. It can analyze trade-offs between different materials, considering factors like cost, performance, and environmental impact.

Communication: It interacts with other agents, such as the Design Specialist Agent, to understand design specifics and suggest the most fitting materials.

Actions: This agent proposes potential material options based on its analysis and can provide detailed information on their properties and suitability for the specific design.

Operation Specialist Agent: This agent plays a crucial role in defining the operating parameters needed for the design to function effectively. Its goal is to suggest appropriate operational conditions and ranges for experimentation or production.

Memory/Database: This agent stores information on process constraints, historical data on past designs (such as curing cycles), air conditions, and initial conditions.

Planning/Reasoning: It analyzes this data to suggest appropriate operating parameters for the specific design. This may involve temperature ranges, pressure levels, or specific processing times.

Communication: It interacts with other agents, such as the Material Specialist Agent, to understand material properties and limitations and with the Design Specialist Agent to ensure the operational parameters align with the design.

Actions: This agent suggests operational parameters and can provide justifications based on its analysis of past data and the design requirements.

Design Specialist Agent: This agent focuses on the core design aspects of the project. Its goal is to propose the actual design based on user requirements, material properties, and operational needs.

Memory/Database: This agent stores information on past design principles, physics models, and manufacturing constraints.

Planning/Reasoning: It utilizes its knowledge base to explore the design space, considering different possibilities and evaluating trade-offs under various constraints. This may involve analyzing performance, cost, and manufacturability.

Communication: It interacts with other agents to gather information and share design ideas. It may consult with the Material Specialist Agent to understand material limitations and with the Operation Specialist Agent to ensure the design can function under the proposed operating parameters.

Actions: This agent proposes specific design solutions and provides justifications based on its analysis and consideration of all relevant factors.

Knowledge Processing Agent: This agent acts as the information hub, searching and managing relevant knowledge for the design process.

Goal: Search, extract, and store domain-specific information from various sources to support design decisions.

Memory/Database: Stores information relevant to the design domain, such as curing-related metadata, predictive models, and potentially historical data from past projects.

Communication: Uses agentic communication to meet requirement gathering needs and tool communication to access web search, pdf and html parsers, retriever, and database operations. Agentic communication: refers to interacting with other agents to request or share information. Tool communication: refers to interacting with various tools and systems to access or process information. For instance, this agent might use web search engines to find relevant information or utilize parsers to extract data from PDFs and HTML files.

Actions: Searches online databases, crawls, and extracts information, updates its knowledge base, and passes relevant information to other agents.

Predictive Model Design Agent: This agent focuses on designing the codebase and configuration for machine learning models used in the design process.

Goal: Design and develop the codebase and configuration for predictive models.

Memory/Database: Not mentioned in the table, but it likely has access to information on machine learning algorithms, model architectures, and potentially pre-trained models.

Communication: Agentic communication, (Predictive Model Optimizer agent controls this agent). Tools: AutoML, model zoos, process execution for model training.

Actions: Designs model architectures, implements training code, benchmarks models on validation data, and reports back the loss and metrics. It utilizes tools like AutoML, model zoos, and process execution for model training

Predictive Model Optimizer Agent: focus on improving the performance of existing machine learning models used within the design process.

Goal: Optimize the performance of existing machine learning models used for design tasks.

Memory/Database: Stores information on past model performance, hyperparameter settings (tuning knobs of a machine learning model) used in past experiments, and potentially metrics used to evaluate model performance.

Planning/Reasoning: Analyzes past model performance data to identify areas for improvement. It explores different hyperparameter configurations to optimize the model's performance based on metrics like accuracy.

Communication: interacts with the Predictive Model Design Agent to receive the model and potentially with other agents to share optimized models.

Actions: Explores different hyperparameter settings, evaluates the performance of the resulting models, and selects the best performing configuration.

Process Optimizer Agent: focus on improving the design process by optimizing real-world experiments.

Goal: Optimize real-world experiments conducted as part of the design process.

Memory/Database: Stores information on past experiment results, including model predictions and actual outcomes. It likely also stores data on objectives or goals set for the experiments.

Planning/Reasoning: Uses a combination of predictive models and past experimental data to determine the most informative experiments to run next. It balances exploring new possibilities (exploitation) with focusing on promising areas based on model predictions (exploration).

Communication: interacts with the Predictive Model Optimizer Agent to get access to the latest models and potentially with the Experiment Enabler Agent to run the designed experiments.

Actions: Selects experiments to run, analyzes the results, and updates its understanding of the design problem based on the new data.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

We claim:

1. A computer-implemented system for designing curing processes using generative AI, the computer-implemented system comprising:
a requirement gathering agent for obtaining design requirements;
an operations specialist agent for determining potential ranges of recipes and operating conditions based on obtained design requirements, material options, and design options;
a material specialist agent for identifying suitable material options and assessing corresponding properties to meet design objectives;
a design specialist agent for defining dimensions and shape aspects of the design based on gathered requirements, material options, and operating conditions;
a knowledge processing and retrieval agent for extracting and reasoning relevant information specific to design, operation, and materials;
an experiment enabler agent for formulating a final requirement specification;
an experiment designer for generating a first set of experiments based on the final requirement specifications;
a predictive model design agent implementing a prediction model for real-time predictions for dynamic conditions;
a predictive model optimizer agent implementing a continual learning framework associated with the prediction model design agent; and
a process optimizer agent associated with the predictive model optimizer agent for optimizing and updating the prediction model iteratively based on feedback from experiments and simulations.

2. The computer-implemented system of claim 1, wherein the prediction model is a physics informed neural operator (PINO) model.

3. The computer-implemented system of claim 1, wherein the prediction model is a pre-trained model and trained using a dataset comprising physics-based simulations and real-world experimental data.

4. The computer-implemented system of claim 1, wherein the prediction model is further trained using the predictive model optimizer agent and predictive model design agent in a semi-supervised fashion based on input variations during an initial stage of virtual curing experiments.

5. The computer-implemented system of claim 1, wherein the first set of experiments is generated using a predefined design of experiments (DOE) approach.

6. The computer-implemented system of claim 1, wherein one or more agents and the optimization component comprises a Generative Artificial Intelligence (Gen AI) model.

7. The computer-implemented system of claim 6, wherein the Gen AI generates structured prompts tailored to specific requirements of a curing process.

8. The computer-implemented system of claim 1, further comprising a graphical user interface (GUI) facilitating user input of design parameters, visualization of optimization results, and a receipt of the feedback.

9. The computer-implemented system of claim 1, wherein the continual learning framework employs at least one of techniques comprising online gradient descent, Bayesian optimization, reinforcement learning, a regularization technique, architectural changes, and data replay mechanisms, to adaptively update the prediction model.

10. The computer-implemented system of claim 1, further comprising a resource management module configured to allocate resources for training, experimental design, and optimization tasks.

11. The computer-implemented system of claim 1, wherein the continual learning framework is configured for updating the prediction model in real-time.

12. A computer-implemented method for designing curing processes, the method comprising:
obtaining design requirements using a requirement gathering agent;
determining potential ranges of recipes and operating conditions with an operations specialist agent based on the obtained design requirements, material options, and design options;
identifying suitable material options and assessing corresponding properties with a material specialist agent to meet design objectives;
defining dimensions and shape aspects of the design using a design specialist agent based on the gathered requirements, material options, and operating conditions;
extracting and reasoning relevant information specific to design, operation, and materials with a knowledge processing and retrieval agent;
formulating a final requirement specification with an experiment enabler agent;
generating a first set of experiments based on the final requirement specifications using an experiment designer;
performing, by a predictive model design agent implementing a prediction model, real-time predictions for dynamic conditions;
updating, by a predictive model optimizer agent implementing a continual learning framework associated with the prediction model design agent, the prediction model in real-time; and
optimizing and updating, by a process optimizer agent associated with the predictive model optimizer agent, the prediction model iteratively based on feedback from experiments and simulations.

13. The computer-implemented method of claim 12, wherein the prediction model is a physics informed neural operator (PINO) model.

14. The computer-implemented method of claim 12, wherein the prediction model is a pre-trained model and trained using a dataset comprising physics-based simulations and real-world experimental data.

15. The computer-implemented method of claim 12, wherein the prediction model is further trained using the predictive model optimizer agent and predictive model design agent in a semi-supervised fashion based on input variations during an initial stage of virtual curing experiments.

16. The computer-implemented method of claim 12, further comprising:
generating, by the Gen AI, structured prompts tailored to specific requirements of a curing process.

17. The computer-implemented method of claim 12, further comprising facilitating, by a graphical user interface (GUI), user input of design parameters, visualization of optimization results, and a receipt of the feedback.

18. The computer-implemented method of claim 12, wherein the continual learning framework employs at least one of techniques comprising online gradient descent, Bayesian optimization, reinforcement learning, a regularization technique, architectural changes, and data replay mechanisms to adaptively update the prediction model.

19. The computer-implemented method of claim 12, further comprising allocating resources for training, experimental design, and optimization tasks.

20. A non-transitory computer-readable storage medium having stored thereon computer executable instruction which when executed by one or more processors, cause the one or more processors to carry out operations for designing curing processes, the operations comprising perform the operations comprising:
obtaining design requirements using a requirement gathering agent;
determining potential ranges of recipes and operating conditions with an operations specialist agent based on the obtained design requirements, material options, and design options;
identifying suitable material options and assessing corresponding properties with a material specialist agent to meet design objectives;
defining dimensions and shape aspects of the design using a design specialist agent based on the gathered requirements, material options, and operating conditions;
extracting and reasoning relevant information specific to design, operation, and materials with a knowledge processing and retrieval agent;
formulating a final requirement specification with an experiment enabler agent;
generating a first set of experiments based on the final requirement specifications using an experiment designer;
performing, by a predictive model design agent implementing a prediction model, real-time predictions for dynamic conditions;
updating, by a predictive model optimizer agent implementing a continual learning framework associated with the prediction model design agent, the prediction model in real-time; and
optimizing and updating, by a process optimizer agent associated with the predictive model optimizer agent, the prediction model iteratively based on feedback from experiments and simulations.
